(19) United States
(12) Patent Application Publication
(10) Pub. No.: US 2011/0254765 A1
(43) Pub. Date: Oct. 20, 2011

(54) Remote text input using handwriting

(75) Inventor: Michael Brand, Victoria (AU)

(73) Assignee: PRIMESENSE LTD., Tel Aviv (IL)

(21) Appl. No.: 12/762,336

(22) Filed: Apr. 18, 2010

(51) Int. Cl. G06F 3/033

(52) U.S. Cl. 345/158

(57) ABSTRACT

A method for user input includes capturing a sequence of positions of at least a part of a body, including a hand, of a user of a computerized system, independently of any object held by or attached to the hand, while the hand delineates textual characters by moving freely in a 3D space. The positions are processed to extract a trajectory of motion of the hand. Features of the trajectory are analyzed in order to identify the characters delineated by the hand.

### FIELD OF THE INVENTION

The present invention relates generally to user interfaces for computerized systems, and specifically to user interfaces that enable text input.

### BACKGROUND OF THE INVENTION

Many different types of user interface devices and methods are currently available. Common tactile interface devices include the computer keyboard, mouse and joystick. Touch screens detect the presence and location of a touch by a finger or other object within the display area. Infrared remote controls are widely used, and “wearable” hardware devices have been developed, as well, for purposes of remote control.

Computer interfaces based on three-dimensional (3D) sensing of parts of the user's body have also been proposed. For example, PCT International Publication WO 03/071410, whose disclosure is incorporated herein by reference, describes a gesture recognition system using depth-perceptive sensors. A 3D sensor provides position information, which is used to identify gestures created by a body part of interest. The gestures are recognized based on the shape of the body part and its position and orientation over an interval. The gesture is classified for determining an input into a related electronic device.

As another example, U.S. Pat. No. 7,348,963, whose disclosure is incorporated herein by reference, describes an interactive video display system, in which a display screen displays a visual image, and a camera captures 3D information regarding an object in an interactive area located in front of the display screen. A computer system directs the display screen to change the visual image in response to the object.

Some computer interfaces use handwriting recognition techniques to derive text input characters from motions made by a user of the computer. For example, U.S. Patent Application Publication 2004/0184640, whose disclosure is incorporated herein by reference, describes a spatial motion recognition system capable of recognizing motions in 3D space as handwriting on a two-dimensional (2D) plane. The system recognizes motions of a system body occurring in space based on position change information of the system body that is detected in a motion detection unit. A control unit produces a virtual handwriting plane having the shortest distances with respect to respective positions in predetermined time intervals and projects the respective positions onto the virtual handwriting plane to recover the motions in space.

As another example, U.S. Patent Application Publication 2006/0159344, whose disclosure is incorporated herein by reference, describes a 3D handwriting recognition method that tracks 3D motion and generates a 2D image for handwriting recognition by mapping 3D tracks onto a 2D projection plane. The method is said to give a final input result in a short time after the user finishes writing a character, without a long waiting time between input of two characters.

### SUMMARY

Embodiments of the present invention that are described hereinbelow provide improved methods for handwriting-based text input to a computerized system based on sensing 3D motion of the user's hand in space.

There is therefore provided, in accordance with an embodiment of the present invention, a method for user input, including capturing a sequence of positions of at least a part of a body, including a hand, of a user of a computerized system, independently of any object held by or attached to the hand, while the hand delineates textual characters by moving freely in a 3D space. The positions are processed to extract a trajectory of motion of the hand, and features of the trajectory are analyzed in order to identify the characters delineated by the hand.

In disclosed embodiments, capturing the sequence includes capturing three-dimensional (3D) maps of at least the part of the body and processing the 3D maps so as to extract the positions. Processing the 3D maps typically includes finding 3D positions, which are projected onto a two-dimensional (2D) surface in the 3D space to create a 2D projected trajectory, which is analyzed in order to identify the characters.

In some embodiments, the motion of the hand delineates the characters by writing on a virtual markerboard.

The motion of the hand may include words written without breaks between at least some of the characters, and analyzing the features may include extracting the characters from the motion independently of any end-of-character indications between the characters in the motion of the hand. In a disclosed embodiment, extracting the characters includes applying a statistical language model to the words in order to identify the characters that are most likely to have been formed by the user. Additionally or alternatively, each word is written in a continuous movement followed by an end-of-word gesture, and extracting the characters includes processing the trajectory of the continuous movement.

There is also provided, in accordance with an embodiment of the present invention, user interface apparatus, including a sensing device, which is configured to capture a sequence of positions of at least a part of a body, including a hand, of a user of the apparatus, independently of any object held by or attached to the hand, while the hand delineates textual characters by moving freely in a 3D space. A processor is configured to process the positions to extract a trajectory of motion of the hand, and to analyze features of the trajectory in order to identify the characters delineated by the hand.

There is additionally provided, in accordance with an embodiment of the present invention, a computer software product, including a computer-readable medium in which program instructions are stored, which instructions, when read by a computer, cause the computer to identify a sequence of positions of at least a part of a body, including a hand, of a user of the computer, independently of any object held by or attached to the hand, while the hand delineates textual characters by moving freely in a 3D space, to process the positions to extract a trajectory of motion of the hand, and to analyze features of the trajectory in order to identify the characters delineated by the hand.

The present invention will be more fully understood from the following detailed description of the embodiments thereof, taken together with the drawings in which:

### BRIEF DESCRIPTION OF THE DRAWINGS

FIG. 1 is a schematic, pictorial illustration of a 3D user interface for a computer system, in accordance with an embodiment of the present invention;

FIG. 2 is a flow chart that schematically illustrates a method for inputting text to a computer system, in accordance with an embodiment of the present invention; and

FIG. 3 is a flow chart that schematically illustrates a method for computerized handwriting recognition, in accordance with an embodiment of the present invention.

### DETAILED DESCRIPTION OF EMBODIMENTS

Methods of computerized handwriting recognition are known in the art, but most require that the user form letters on an actual physical surface and/or use a stylus or other implement to form the letters. By contrast, embodiments of the present invention permit the user to form letters by freehand motion in 3D space. In this way, the user may input text to a computer, for example, by making hand motions that emulate writing on a “virtual markerboard,” i.e., by moving his or her hand over an imaginary, roughly planar surface in space. This sort of hand motion resembles writing on a physical chalkboard or whiteboard, and so is intuitively easy for users to adopt, but does not require the user to hold any sort of writing implement or other object.

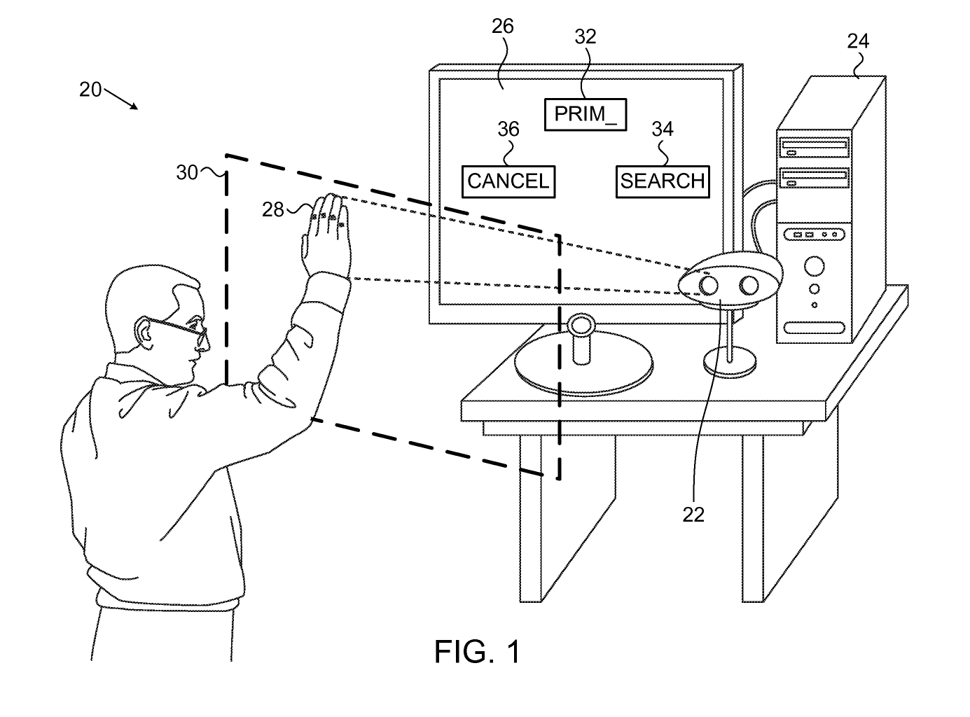

FIG. 1 is a schematic, pictorial illustration of a 3D user interface system 20 for operation by a user of a computer 24, in accordance with an embodiment of the present invention. The user interface is based on a 3D sensing device 22, which captures 3D scene information that includes at least a part of the body of the user, and specifically includes a hand 28 of the user. Device 22 may also capture video images of the scene. Device 22 outputs a sequence of frames containing 3D map data (and possibly color image data, as well). The data output by device 22 is processed by computer 24, which drives a display screen 26 accordingly.

Computer 24 processes data generated by device 22 in order to reconstruct a 3D map of at least a part of the user's body. Alternatively, the 3D map may be generated by device 22 itself, or the processing functions may be distributed between device 22 and computer 24. The term “3D map” refers to a set of 3D coordinates representing the surface of a given object, in this case hand 28 and possibly other parts of the user's body. In one embodiment, device 22 projects a pattern of spots onto the object and captures an image of the projected pattern. Device 22 or computer 24 then computes the 3D coordinates of points on the surface of the user's body by triangulation, based on transverse shifts of the spots in the pattern. This approach is advantageous in that it does not require the user to hold or wear any sort of beacon, sensor, or other marker. Methods and devices for this sort of triangulation-based 3D mapping using a projected pattern are described, for example, in PCT International Publications WO 2007/043036, WO 2007/105205 and WO 2008/120217, whose disclosures are incorporated herein by reference. Alternatively, system 20 may use other methods of 3D mapping, using single or multiple cameras or other types of sensors, as are known in the art.

In the present embodiment, computer 24 captures a sequence of three-dimensional (3D) maps containing hand 28, while the user moves the hand to delineate textual characters by moving freely in 3D space. The motion of the hand delineates the characters by “writing” on a virtual markerboard 30, corresponding roughly to a planar locus in 3D space. There is no need, however, for the user to hold any writing implement or other object in the writing hand. The user may move hand 28 so as to form cursive or other continuous writing, without end-of-character indications or other breaks between at least some of the characters. Each word is thus written in a continuous movement, typically progressing from left to right across markerboard 30, possibly followed by an end-of-word gesture, which returns the hand to the starting position for the next word. The user's gestures may form shapes of conventional written text, or they may use a special alphabet that is adapted for easy recognition by computer 24.

Computer 24 processes the 3D map data provided by device 22 to extract 3D positions of hand 28, independently of any object that might be held by the hand. The computer projects the 3D positions onto a 2D surface in 3D space, which is typically (although not necessarily) the plane of virtual markerboard 30, and thus creates a 2D projected trajectory. The computer then analyzes features of the projected trajectory in order to identify the characters delineated by the hand. The computer typically presents these characters in a text box 32 on screen 26. The screen may also present other interactive controls 34, 36, which enable the user, for example, to initiate a search using the text input in box 32 as a query term and/or to perform various editing functions.

Computer 24 typically comprises a general-purpose computer processor, which is programmed in software to carry out the functions described hereinbelow. The software may be downloaded to the processor in electronic form, over a network, for example, or it may alternatively be provided on tangible media, such as optical, magnetic, or electronic memory media. Alternatively or additionally, some or all of the functions of the computer may be implemented in dedicated hardware, such as a custom or semi-custom integrated circuit or a programmable digital signal processor (DSP). Although computer 24 is shown in FIG. 1, by way of example, as a separate unit from sensing device 22, some or all of the processing functions of the computer may be performed by suitable dedicated circuitry within the housing of the sensing device or otherwise associated with the sensing device.

As another alternative, these processing functions may be carried out by a suitable processor that is integrated with display screen 26 (in a television set, for example) or with any other suitable sort of computerized device, such as a game console or media player. The sensing functions of device 22 may likewise be integrated into the computer or other computerized apparatus that is to be controlled by the sensor output.

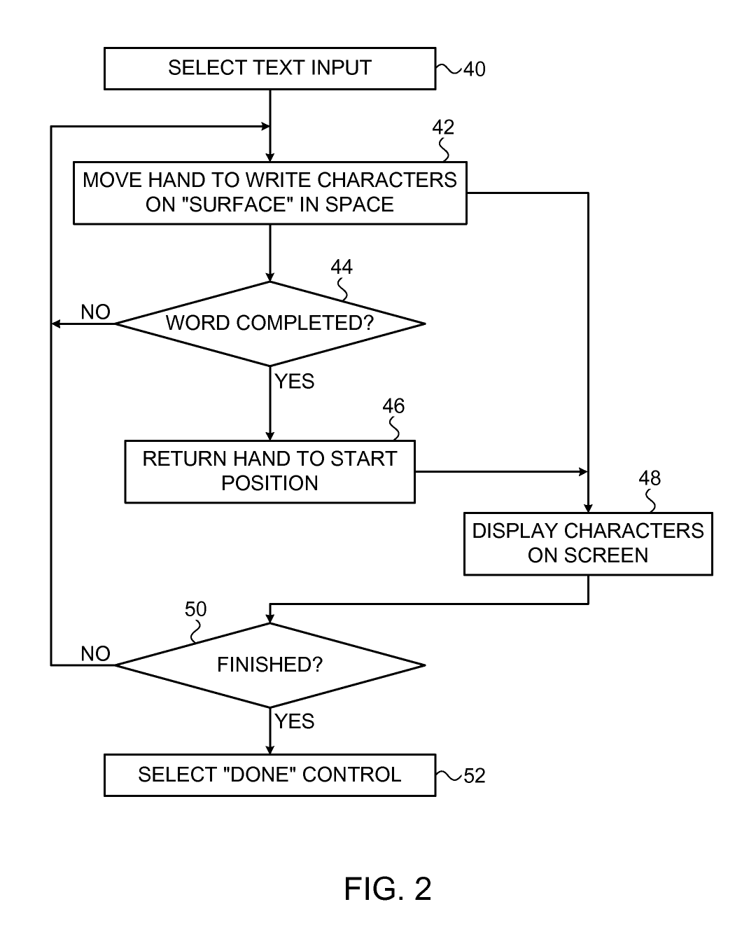

FIG. 2 is a flow chart that schematically illustrates a method for inputting text to system 20, in accordance with an embodiment of the present invention. To begin inputting text, the user typically makes some initial gesture or sequence of gestures, at an input selection step 40. For example, the user may make a circular movement of hand 28, which computer 24 interprets as a request to display a menu on screen 26, after which the user points to the menu item corresponding to text input. Alternatively, other modes of selection may be used to invoke text input, or the computer may be configured as a default to interpret hand movements as text input, so that step 40 is not needed.

The user moves hand 28 over virtual markerboard 30 so as to write characters on the markerboard “surface,” at a hand motion step 42. This surface need not be defined in advance, but may rather be inferred by computer 24 based on the user's hand motions. For example, the computer may fit a plane or other 2D surface to the actual trajectory of hand motion. The user is then free to choose the virtual writing surface that is most convenient and comfortable. Alternatively or additionally, the computer provide visual feedback on display 26 to indicate to the user that hand 28 is in the appropriate 3D range for text input.

As noted above, the writing created at step 42 may be cursive and may include an end-or-word gesture. The alphabet recognized by computer 24 may also include other gestures to invoke special characters, such as punctuation marks and symbols. The term “character,” in the context of the present patent application, includes all such letters, numbers, marks and symbols. The user may also make predefined editing gestures, such as gestures for insertion and deletion of characters. Computer 24 may carry out a training session with each user in order to learn the user's handwriting in advance. Alternatively, the computer may use generic statistical models in performing handwriting recognition.

The user adds characters in sequence in the appropriate writing direction (such as left-to-right) until he or she has completed a word, at a word completion step 44. After completing a word, the user then moves hand 28 back to the starting position, at an end-of-word step 46. Computer 24 recognizes and uses this motion in segmenting words, particularly when the user input two or more words in sequence.

Computer 24 displays the characters that the user has input on screen, in text box 32, for example, at a character display step 48. The computer need not wait until the user has finished writing out the current word, but may rather display the letters as soon as the user has written them on the virtual markerboard. The computer typically decodes the motion of hand 28 using a statistical model, which estimates and chooses the characters that are most likely to correspond to the hand movements. The likelihood estimation is updated as the user continues to gesture, adding characters to the current word, and the computer may update and modify the displayed characters accordingly.

The user continues gesturing until the entire word or phrase for input is displayed on screen 26, at a completion step 50. The user then selects the appropriate control (such as search button 34) to invoke the appropriate action by computer 24 based on the text input, at a control step 52.

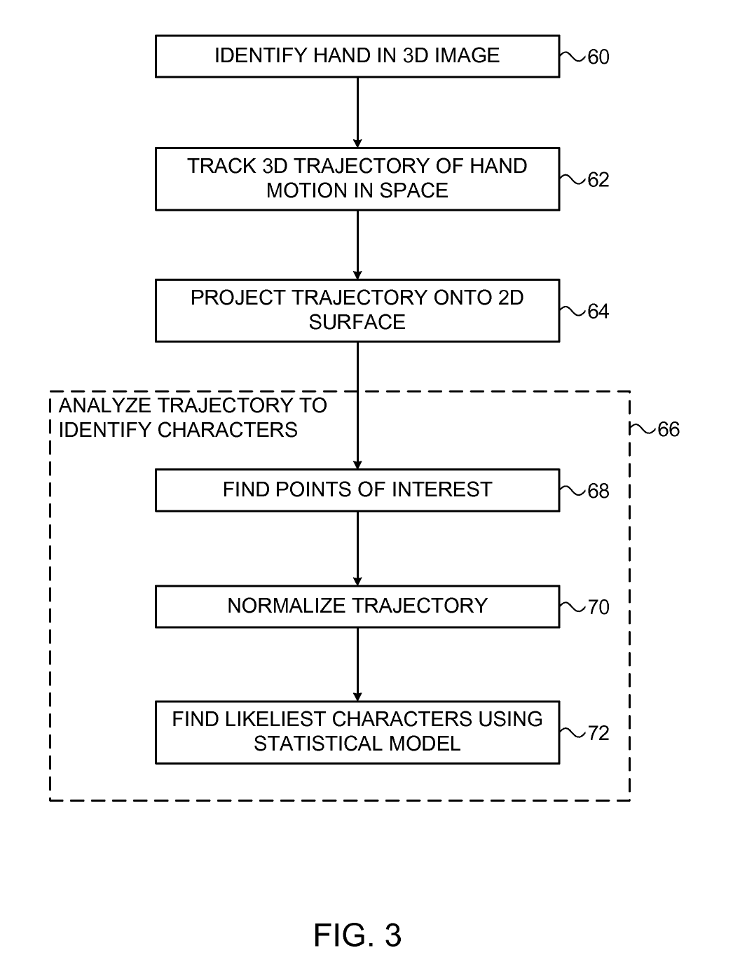

FIG. 3 is a flow chart that schematically illustrates a method for computerized handwriting recognition, in accordance with an embodiment of the present invention. This method is carried out by computer 24 in system 20 in order to recognize and display the characters formed by movements of hand 28 in the steps of FIG. 2, as described above.

In order to recognize gestures made by hand 28, computer 24 first identifies the hand itself in the sequence of 3D map frames output by device 22, at a hand identification step 60. This step typically involves segmentation based on depth, luminance and/or color information in order to recognize the shape and location of the hand in the depth maps and distinguish the hand from the image background and from other body parts. One method that may be used for this purpose is described in U.S. Patent Application Publication 2010/0034457, whose disclosure is incorporated herein by reference. Another method, based on both depth and color image information, is described in U.S. Provisional Patent Application 61/308,996, filed Mar. 1, 2010, which is assigned to the assignee of the present patent application and whose disclosure is also incorporated herein by reference. Computer 24 may use hand location and segmentation data from a given frame in the sequence as a starting point in locating and segmenting the hand in subsequent frames.

Based on the sequence of frames and the hand location in each frame, computer 24 finds a sequence of 3D positions of the hand over the sequence of frames, which is equivalent to constructing a 3D trajectory of the hand, at a trajectory tracking step 62. The trajectory may be broken in places where the hand was hidden or temporarily stopped gesturing or where the tracking temporarily failed. The trajectory information assembled by the computer may include not only the path of movement of hand 28, but also speed and possibly acceleration along the path.

Computer 24 projects the 3D positions (or equivalently, the 3D trajectory) onto a 2D surface, at a projection step 64. The surface may be a fixed surface in space, such as a plane perpendicular to the optical axis of device 22 at a certain distance from the device. Alternatively, the user may choose the surface either by explicit control in system 20 or implicitly, in that computer chooses the surface at step 64 that best fits the 3D trajectory that was tracked in step 62. In any case, the result of step 64 is a 2D trajectory that includes the path and possibly speed and acceleration of the hand along the 2D surface.

Computer 24 analyzes the 2D trajectory to identify the characters that the user has spelled out, at a character identification step 66. This step typically involves statistical and probabilistic techniques, such as Hidden Markov Models (HMM). A variety of different approaches of this sort may be used at this stage, of which the following steps are just one example:

The computer finds points of interest along the trajectory, at a point identification step 68. These points are typically characterized by changes in the position, direction, velocity and/or acceleration of the trajectory. The computer normalizes the position and size of the writing based on the trajectory and/or the points of interest, at a normalization step 70. The computer may also normalize the speed of the writing, again using clues from the trajectory and/or the points of interest.

The normalized trajectory can be considered as the output (i.e., the observable variable) of a HMM process, while the actual characters written by the user are the hidden variable. Computer 24 applies a suitable HMM solution algorithm (such as state machine analysis, Viterbi decoding, or tree searching) in order to decode the normalized trajectory into one or more candidate sequences of characters. Each candidate sequence receives a probability score at this stage, and the computer typically chooses the sequence with the highest score, at a character selection step 72.

The probability scores are typically based on two components: how well the trajectory fits the candidate characters, and how likely the list of characters is as a user input. These likelihood characteristics can be defined in various ways. For fitting the trajectory to the characters, for example, the characters may themselves be defined as combinations of certain atomic hand movements from an alphabet of such movements (characterized by position, direction, velocity, acceleration and curvature). The probability score for any given character may be determined by how well the corresponding trajectory matches the list of atomic movements that are supposed to make up the character. A list of atomic movements that cannot be made into a list of letters may receive no score at all.

Sequences of characters can be given a likelihood score based on a statistical language model, for example. Such a model may define letter-transition probabilities, i.e., the likelihood that certain letters will occur in sequence. Additionally or alternatively, computer 24 may recognize entire words from a predefined dictionary and thus identify the likeliest word (or words) written by the user even when the individual characters are unclear. In this manner, word recognition by computer 24 may supersede character recognition and enable the computer to reliably decode cursive characters drawn by the user on the virtual markerboard.

Alternatively, other suitable recognition methods, as are known in the art, may be used in decoding the projected 2D handwriting trajectory into the appropriate character string. It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for user input, comprising:
capturing a sequence of positions of at least a part of a body, including a hand, of a user of a computerized system, independently of any object held by or attached to the hand, while the hand delineates textual characters by moving freely in a 3D space;
processing the positions to extract a trajectory of motion of the hand; and
analyzing features of the trajectory in order to identify the characters delineated by the hand.

2. The method according to claim 1, wherein capturing the sequence comprises capturing three-dimensional (3D) maps of at least the part of the body and processing the 3D maps so as to extract the positions.

3. The method according to claim 2, wherein processing the 3D maps comprises finding 3D positions, and wherein processing the positions comprises projecting the 3D positions onto a two-dimensional (2D) surface in the 3D space to create a 2D projected trajectory, and wherein analyzing the features comprises analyzing the projected trajectory.

4. The method according to claim 1, wherein the motion of the hand delineates the characters by writing on a virtual markerboard.

5. The method according to claim 1, wherein the motion of the hand comprises words written without breaks between at least some of the characters, and wherein analyzing the features comprises extracting the characters from the motion independently of any end-of-character indications between the characters in the motion of the hand.

6. The method according to claim 5, wherein extracting the characters comprises applying a statistical language model to the words in order to identify the characters that are most likely to have been formed by the user.

7. The method according to claim 5, wherein each word is written in a continuous movement followed by an end-of-word gesture, and wherein extracting the characters comprises processing the trajectory of the continuous movement.

8. User interface apparatus, comprising:
a sensing device, which is configured to capture a sequence of positions of at least a part of a body, including a hand, of a user of the apparatus, independently of any object held by or attached to the hand, while the hand delineates textual characters by moving freely in a 3D space; and
a processor, which is configured to process the positions to extract a trajectory of motion of the hand, and to analyze features of the trajectory in order to identify the characters delineated by the hand.

9. The apparatus according to claim 8, wherein the sensing device is configured to capture three-dimensional (3D) maps of at least the part of the body, and wherein the processor is configured to process the 3D maps so as to extract the positions.

10. The apparatus according to claim 9, wherein the processor is configured to extract 3D positions from the 3D maps and to project the 3D positions onto a two-dimensional (2D) surface in the 3D space to create a 2D projected trajectory, and to analyze the projected trajectory in order to identify the characters.

11. The apparatus according to claim 8, wherein the motion of the hand delineates the characters by writing on a virtual markerboard.

12. The apparatus according to claim 8, wherein the motion of the hand comprises words written without breaks between at least some of the characters, and wherein the processor is configured to extract the characters from the motion independently of any end-of-character indications between the characters in the motion of the hand.

13. The apparatus according to claim 12, wherein the processor is configured to apply a statistical language model to the words in order to identify the characters that are most likely to have been formed by the user.

14. The apparatus according to claim 12, wherein each word is written in a continuous movement followed by an end-of-word gesture, and wherein the processor is configured to extract the characters by processing the trajectory of the continuous movement.

15. A computer software product, comprising a computer-readable medium in which program instructions are stored, which instructions, when read by a computer, cause the computer to identify a sequence of positions of at least a part of a body, including a hand, of a user of the computer, independently of any object held by or attached to the hand, while the hand delineates textual characters by moving freely in a 3D space, to process the positions to extract a trajectory of motion of the hand, and to analyze features of the trajectory in order to identify the characters delineated by the hand.

16. The product according to claim 15, wherein the instructions cause the computer to receive and process three-dimensional (3D) maps of at least the part of the body so as to extract the positions.

17. The product according to claim 16, wherein the instructions cause the computer to extract 3D positions from the 3D maps and to project the 3D positions onto a two-dimensional (2D) surface in the 3D space to create a 2D projected trajectory, and to analyze the projected trajectory in order to identify the characters.

18. The product according to claim 15, wherein the motion of the hand delineates the characters by writing on a virtual markerboard.

19. The product according to claim 15, wherein the motion of the hand comprises words written without breaks between at least some of the characters, and wherein the instructions cause the computer to extract the characters from the motion independently of any end-of-character indications between the characters in the motion of the hand.

20. The product according to claim 19, wherein the instructions cause the computer to apply a statistical language model to the words in order to identify the characters that are most likely to have been formed by the user.

21. The product according to claim 19, wherein each word is written in a continuous movement followed by an end-of-word gesture, and wherein the instructions cause the computer to extract the characters by processing the trajectory of the continuous movement.
